(19) United States
(12) Patent Application Publication
(10) Pub. No.: US 2016/0128322 A1
(43) Pub. Date: May 12, 2016

(54) Disinfectant Bleach Foam Formulation

(71) Applicant: The Trustees of Columbia University in The City Of New York, New York, NY (US)

(72) Inventors: Ponisseril Somasundaran, Nyack, NY (US); Partha Patra, New York, NY (US); Jun Wu, New York, NY (US)

(21) Appl. No.: 14/933,876

(22) Filed: Nov. 5, 2015

Related U.S. Application Data
(60) Provisional application No. 62/075,682, filed on Nov. 5, 2014.

(51) Int. Cl. A01N 25/16; A01N 59/00

(52) U.S. Cl. CPC A01N 25/16; A01N 59/00

(57) ABSTRACT

The disclosed subject matter relates to a bleach foam formulation, and to methods of use of the bleach foam formulation for the decontamination of surfaces exposed to infectious agents. disclosed subject matter provides a method for the delivery of the bleach foam formulation for the decontamination of surfaces, and specifically for the decontamination of health workers' personal protection suits, exposed to Ebola, SARS or other infectious agents. In certain embodiments, the use of the bleach foam formulation involves the delivery of the bleach foam from distances for the safe disinfection of contaminated surfaces.

### CROSS-REFERENCE TO RELATED APPLICATIONS

This application claims priority to U.S. Application No. 62/075,682, filed Nov. 5, 2014, which is incorporated herein by reference in its entirety.

### BACKGROUND

Disinfection of surfaces in facilities, such as hospitals, laboratories, restaurants, food-processing facilities, etc. is performed to treat contaminated surfaces and inhibit the spread of infectious agents (bacteria and virus). Surfaces in healthcare settings, such as hospitals, and including floors, drains, bathroom/shower facilities, medical equipment and personal protective equipment (i.e., protective/biohazard suits) can become contaminated with infectious agents that require control.

### SUMMARY

The disclosed subject matter provides an easy and inexpensive method for the more effective decontamination of personal protective suits and other contaminated surfaces by the application of a disinfectant bleach foam which adheres to the surface and penetrates cracks and pores in the surface to kill infectious agents, such as the Ebola virus. As opposed to the cumbersome practices associated with the direct usage of the concentrated bleach solution for personnel decontamination purposes, usage of the bleach foam composition disclosed herein offers an easier and more reliable alternative.

The disclosed subject matter provides a disinfectant bleach foam that allows for improved application to contaminated surfaces, including personal protective gear, for the decontamination of the affected surfaces. The bleach foam has been developed to provide the proper consistency, rheological behavior and stability to allow improved application and decontamination of the affected surfaces.

The disinfectant bleach foam provides a range of features and advantages, particularly over conventional disinfectant bleach solutions. The disinfectant bleach foam allows the application of the disinfectant to surfaces that are difficult to reach or even hazardous to approach too closely. Because the disinfectant bleach foam adheres to surfaces, as opposed to bleach solutions that splash off, the bleach foam can be applied to difficult to reach and/or vertical surfaces. The disinfectant bleach foam can be applied on ceilings, fixtures and areas below the beds and tables.

Additionally, the disinfectant bleach foam provides a more uniform deposition of bleach and at a potentially faster rate. In current practices, sprayers are used to disinfect hospital walls, suits, patient's beds, excreta, spilled fluids and the like. Decontamination may be required for a longer time (30 minutes) with bleach solution and the effectiveness of the decontamination depends on how uniformly the bleach solution is applied.

The disinfectant bleach foam also provides a safer option in terms of both bleach delivery and an improved assessment of decontamination. The safer delivery of disinfectant (bleach) provided by the bleach foam includes considerations such as minimum contact of health workers with the contaminated areas, lower accidental exposure to the bleach by the person applying the disinfectant and lower spread of the disinfectant from the contaminated surface or area to other areas. The disinfectant bleach foam also provides a discernable indication of disinfectant application to ensure complete coverage. While application of bleach solution on a surface provides a wet patch, it does not necessarily provide sufficient and uniform contact with the disinfecting agent. In contrast, the bleach foam can be seen on a surface as a white foam, and any uncovered areas can be identified easily. Importantly, a person can decontaminate a surface (such as another person's protection suit) from a safe distance, for example 6-10 feet away.

In the case were contaminated bodily fluid has spread on a floor, moping is typically done to remove the fluid. For corpse decontamination, direct handing of bodies is often seen. In these cases the risk of infection can be significantly minimized through deployment of bleach foam from a safe distance.

For application of bleach solutions for decontamination, currently a 1:10 and 1:100 bleach-to-water ratio has been suggested by CDC. When using the disinfectant bleach foam, decontamination may be achieved in lower ratios for certain embodiments. Use of the bleach foam for decontamination can also result in significantly less water consumption. An added feature in using less overall bleach for decontamination is that the seepage through the ground will be less. Also, the surfactant and polymer constituents can be selected to have low environmental impact.

The bleach foam composition comprises a disinfectant such as a hypochlorite, as the disinfecting agent. The bleach foam composition also comprises one or more surfactants, and one or more polymers, which provide the foam consistency, texture (bubbles size distribution), stability, rheology, and adhesion for the effective decontamination of surfaces exposed to an infectious agent.

The disclosed subject matter also provides a method for the delivery of the disinfectant bleach foam formulation for the decontamination of surfaces, and specifically for the decontamination of health workers' suits exposed to Ebola or other infectious agents. In certain embodiments, the use of the bleach foam formulation involves the delivery of the bleach foam from distances for the safe disinfection of contaminated surfaces.

### BRIEF DESCRIPTION OF THE FIGURES

FIG. 1 shows the plot of the foam volume against time for foams comprising the surfactants sodium lauryl ether sulfate (A) and lauramidopropyl betaine (B) in different ratios (1:3-3:1 wt:wt).

FIG. 2 shows a schematic representation of the application of the disinfectant bleach foam composition with as a pressurized spray for the decontamination of a personal protective suit.

### DETAILED DESCRIPTION

The disclosed subject matter relates to a bleach foam formulation, and to methods of using or applying the bleach foam formulation. The disclosed subject matter provides a method for the delivery of the bleach foam formulation for the decontamination of surfaces, and specifically for the decontamination of health workers' biohazard suits exposed to Ebola, SARS or other infectious agents. In certain embodiments, the use of the bleach foam formulation involves the delivery of the bleach foam from distances for the safe disinfection of contaminated surfaces.

Chlorine compounds have been used in various types of cleaning, bleaching and sanitizing compositions. Chlorine compounds used in this regard include, for example, sodium hypochlorite, which is found in common bleach solutions.

The recent outbreak of Ebola has exposed a number of difficulties in dealing with the risk to health workers, family members and the local communities of the spread of the Ebola virus (and by extension, other infectious agents). While the Center for Disease Control has issued a new set of hospital guidelines in an effort to limit the spread of Ebola, the fundamental problem of the spread of the disease due to contamination poses a serious threat. Under the present threat, providing a robust decontamination strategy, which is easy to adapt to both controlled laboratory settings and to remote places, is an important step in dealing with the threat of Ebola contamination rapidly and effectively. As part of the current decontamination practices, bleach solutions are used in hospitals, on the protective suits of health workers, and areas accessible to health workers, infected patients and contaminated bodies. These bleach solutions when sprayed on most hydrophobic surfaces, such as those of the personal protective suits, have a tendency to bead up and run off of the suit material without necessarily killing the viruses during the short contact time. Accordingly, there is a need for reliable compositions and methods for the safe and effective decontamination of surfaces exposed to infectious agents including Ebola.

The disclosed subject matter provides an easy and inexpensive method for the more effective decontamination of surfaces exposed to infectious agents such as Ebola. The disinfectant bleach foam composition can be used to disinfect surfaces including personal protective suits (biohazard suits) and other contaminated surfaces accessible to health workers, infected patients and contaminated bodies.

The disinfectant bleach foam disclosed herein adheres to the contaminated surface and penetrates crevices or pores to kill the Ebola virus or other infectious agent. The disinfectant bleach foam has improved surface coverage and contact time as compared to conventional bleach solutions, which may bead up on surfaces and run off of the surface. Accordingly, the disclosed subject matter provides a disinfectant bleach foam that allows for improved application to contaminated surfaces, including personal protective gear, for the decontamination of the affected surfaces. The disinfectant bleach foam has been developed to provide the proper consistency, rheological behavior and stability to allow improved application and decontamination of the affected surfaces.

The disclosed subject matter also provides a method for the delivery of the disinfectant bleach foam composition for the decontamination of surfaces, and specifically for the decontamination of health workers' suits exposed to Ebola or other infectious agents. In certain embodiments, the use of the bleach foam composition involves the delivery of the bleach foam from distances for the safe disinfection of contaminated surfaces.

The foam composition comprising a disinfectant such as a hypohalite, one or more compatible surfactants, and one or more polymers. The proper selection of these components provides a robust disinfecting foam with the proper foam consistency, texture (in terms of bubbles size distribution), stability, rheology, and adhesion for the effective decontamination of surfaces exposed to an infectious agent. The composition can be employed for the decontamination of hydrophobic surfaces. Control over consistency and texture of the foam is further achieved by manipulating the air-water-surfactant ratios, stability by optimizing surfactant type, polymer, and mixing ratios, and rheological properties by the selection of polymers.

A disinfecting agent for use in the disinfectant foams disclosed herein is bleach. The term “bleach” as it is referred to herein refers to a hypohalite bleach, and in particular a hypochlorite bleach.

As used herein, the term “hypochlorite” is used to describe both a hypochlorite and hypochlorite generating agents. Hypochlorite and compounds producing hypochlorite in aqueous solution are useful in the disinfectant bleach foams, and particularly sodium hypochlorite (NaOCl) and potassium hypochlorite (KOCl).

Generally, the hypochlorite component of the composition can be provided by a variety of sources. Hypochlorites can be formed, for example, by reaction of hypochlorous acid with sodium hydroxide (or other metal hydroxides) in order to produce the corresponding hypochlorite with water. Hypochlorite compounds or compounds producing hypochlorite or hypohalite in aqueous solution can be used in the foams. Representative hypohalite-producing compounds include sodium, potassium, lithium and calcium hypochlorite, chlorinated trisodium phosphate dodecahydrate, potassium and sodium dichloroisocyanurate and trichlorocyanuric acid. Other hypohalite and hypohalite producing compounds are well known for use in bleaching compositions and are also contemplated for use in the disinfectant foam compositions.

Additional or alternative disinfectant agents can be used in the foam formulations. The additional/alternative disinfectant can include biocidal agents such as the quaternary ammonium biocidal agents, for example, alkyldimethyl-benzylammonium chloride, alkyldimethyl ethyl benzyl ammonium chloride, etc.

The disinfectant bleach foam composition comprises sufficient bleach to disinfect the contaminated surface in the contact time between the bleach foam and the surface. The disinfectant bleach foam formulations comprise from about 0.5% to about 18% by weight of the disinfecting agent, and in certain embodiments from about 1% to 10%. In certain embodiments, contact times can be as long as about 30 minutes. Contact times between the bleach foam and the surface are about 0.5 to about 10 minutes for most applications. In many applications, a contact time between the bleach foam and the surface is about 0.5 to about 5 minutes.

The disinfectant bleach foam formulations additionally comprise one or more surfactants. The surfactant(s) used in the bleach foam formulations provide the foaming property to the formulation and ideally provide a stable, long-lasting foam. Accordingly, surfactants are selected to have high foaming properties to provide a fine textured, long lasting foam.

The surfactant(s) can be selected from a wide variety of surfactants including betaines, alkyl ether sulfates, alkyl sulfates, alkyl sulfonates, alkyl aryl sulfonates, alkyl phenol ether sulfates, amine oxides, alkyl diphenyl oxide sulfonates, alkyl phosphonates, alkyl phosphate esters, etc., and mixtures thereof. The surfactants can have alkyl chains comprising from about 8 to 18 carbon atoms in the alkyl group.

In certain embodiments, the disinfectant bleach foam composition includes a surfactant that is selected from the class of anionic surfactants. Anionic surfactants can include alkyl ether sulfates, alkyl sulfates, alkyl sulfonates, K myristate, K caparate and K laurate. Particularly, alkyl ether sulfate, alkyl sulfate and alkyl sulfonate surfactants having from about 8 to 18 carbon atoms in the alkyl group can be used in the bleach foam. A particularly alkyl ether sulfate surfactant used in the bleach foam compositions is SLES (Sodium lauryl ether sulfate).

A second group of anionic surfactant materials suitable for the disinfectant bleach foam compositions include betaine surfactants. The betaine surfactants can have from about 8 to 18 carbon atoms in the alkyl group. A particularly betaine surfactant is LAPB (Lauramidopropyl Betaine).

The disinfectant bleach foam formulations comprise sufficient surfactant(s) to provide the desired foaming characteristics to the composition. In certain embodiments, the disinfectant bleach foam formulations comprise from about 0.001% to about 10% by weight of the surfactant(s), and in other embodiments the range is from about 0.005 to 5% by weight, or the range is from about 0.01% to about 2% by weight.

The disinfectant bleach foam composition additionally comprises one or more polymers. The polymer(s) used in the bleach foam formulations provide the proper rheological properties to the bleach foam. The polymer may also assist in the formation of a stable foam.

A class of polymers for use in the disinfectant foam compositions are cellulose derivatives and cationic polysaccharides. Cationic polysaccharide polymers include cationic polymers derived from a natural gum, such as guar hydroxypropyltrimonium chloride (commercially available as Jaguar). Cellulose derivatives include carboxymethyl cellulose.

The disinfectant bleach foam composition comprises sufficient polymer(s) to provide the desired rheological properties to the bleach foam. In certain embodiments, the disinfectant bleach foam composition comprises from about 0.01% to about 2% by weight of the polymers(s) in the composition, and in other embodiments, from about 0.05% to about 1% by weight.

The disinfectant bleach foam composition can comprise optional additional components selected from fragrance, colorants, buffers/pH adjusting agents, stabilizers, chelating agents, etc.

A pH adjusting agent can be added to the disinfectant bleach foam composition for control of the pH of the composition. The pH of the composition can be greater than about 4.5, or can be greater than about 7, and less than about 12. pH adjusting agents include any suitable organic or inorganic acids and bases. The basic pH adjusting agent can be selected from a carbonate, bicarbonate, hydroxide, or mixtures thereof. Acids include mineral acids (hydrochloric acid, sulfuric acid, etc.), carboxylic acids, sulfonic acids, and the like.

In embodiments in which the composition is a binary composition, it may be desired that the bleach solution is stored at a pH that is different from the surfactant/polymer composition. For example, it can be beneficial to store the bleach solution at an alkaline pH, while the surfactant/polymer solution is stored at a lower pH. A pH adjusting agents can be added to the disinfectant bleach foam composition such that when the first liquid component (bleach) and second liquid component (surfactant/polymer) are mixed the resulting pH of the admixture is typically lower as compared to the bleach solution.

The bleach foam composition can comprise one or more stabilizers. The stabilizers are added to impart improved stability to the foam, which in turn allows for a prolonged contact time between the bleach foam and the surface. In certain embodiments the stabilizer comprises fine particulate materials, and includes fine mineral particles such as talc.

The bleach foam composition can also comprise one or more wetting agents or “super spreaders.” The super spreader can be selected from the silicon (siloxane) super spreaders which are commercially available.

The composition can be provided as a single solution comprising the bleach, surfactant(s), polymer(s) and optional components, or can be provided as a binary formulation comprising two or more separate liquids. In certain embodiments, the composition is provided as two liquid compositions: a first liquid composition comprising the bleach disinfectant, and a second liquid composition comprising the surfactant(s) and polymer(s). In the binary composition, the two liquids can be maintained separately prior to mixing just before or during the spray application of the bleach foam to a surface.

The disinfectant foam composition can be applied to a surface by spraying the composition onto the surface. In certain embodiments, the foam composition is sprayed onto the surface from a distance of at least about 3 feet, or from a distance of at least about 6 feet. Accordingly, the disinfectant bleach foam composition can be applied to the surface for decontamination using a high pressure spray apparatus.

A range of delivery devices can be used to apply with the bleach foam formulation. The delivery device can be a pressurized spray device. The delivery device can be selected from foam lancer, fertilizer sprayer, pressurized sprayer, hand pressurized sprayer, pressurized canister, or the like.

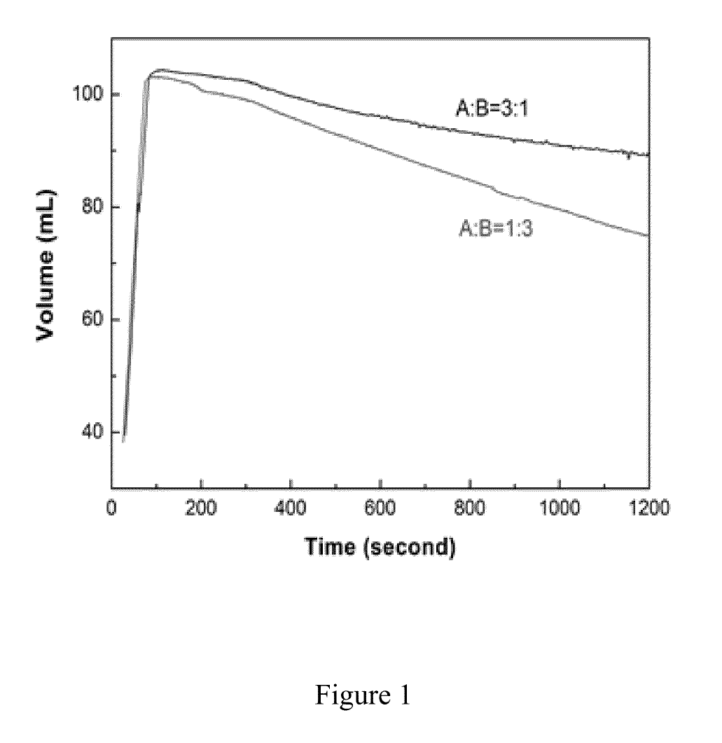

The bleach foam is a stable foam to allow for sufficient contact time for the decontamination of the surface. Accordingly, the bleach foam has a high stability after the foam has been applied to the surface. The stability of static foams is fundamentally the rate at which the total area of the liquid lamellae disappears. These measurements can be obtained photographically or by digital image analysis. Additionally or alternatively, the stability of the foam can be reported as the slope from the plot of the foam volume against time (see FIG. 1).

The foam can break after sufficient contact time for decontamination has been achieved. This allows for easier disposal of the foam from the decontaminated surface. The foam may break do the nature of the foam composition. Alternatively, an agent can be applied to the foam to assist in the process of breaking the foam.

As discussed above, bleach solutions presently used in the decontamination of surfaces may bead up and/or run off of surfaces, particularly when the surface is hydrophobic. In contrast, the bleach foams adhere to hydrophobic surfaces and allow improved decontamination of the surface. Adhesion, as it is used herein, refers to the ability of the foam to adhere to a vertical surface.

The bleach foam has a fine texture, i.e., that the foam comprises bubbles that are small and uniform, which allows for more efficient decontamination of the surface to which the foam is applied. In the present context, the foam texture refers to the bubble size distribution of the foam. In embodiments providing improved penetration into cracks and pores, the foam comprises bubble sizes on the micron or nanometer scale. The foam texture in terms of bubble sizes can be in the range of 500 nm to 5 mm size.

The fine texture of the bleach foams allows for more complete coverage of the surface and allows for more effective decontamination of any pores or crevices in the surface. The texture can be influenced by the regulation of the air/liquid ratio in the spray applicator. Air-to-solution ratios can range from about 200:1 to 1,000:1 to produce high expansion ratio foam and fine textured foam.

The bleach foam has rheological properties that allow the foam to adhere to the contaminated surface, and particularly to a vertical surface, without substantially running off of the surface. Accordingly, the bleach foams have sufficient thickness and viscosity to provide a prolonged contact time with a vertical contaminated surface.

The stability of foams is dependent on interfacial properties, which play an important role in inhibiting the coalescence of bubbles or film drainage of foams. Surface-active additives adsorb at the air/liquid interface, often building a monolayer with a thickness of only a few nanometers. This interface can be investigated with a rheometer, which provides information on the dynamics of the film formation as well as the rheological properties of the final film.

In certain embodiments, the aim is to obtain a narrow size distribution of the smaller bubbles, where the viscous fluid in the foam will enable longer stability. These factors can be studied through the determination of two parameters—yield stress and viscosity—using MCR Anton Paar Rheometer. Foam texture can be determined using a phase contrast microscope, where the size and morphology of the bubbles are determined for the formulation types and as a function of time. These values may then be correlated to the respective rheological values. By selection of the surfactants, polymers, and additional modifiers, the properties of the resultant foam can be controlled. This allows, for example, control of the foam flow. Polymeric associative thickeners can be added where the low shear viscosity is high and high shear viscosity is very low.

It will be recognized that the weight percents of the ingredients in the bleach foam composition of the invention may be adjusted to attain the desired results, such as foam texture, stability, etc. It will also be recognized that the bleach foam composition of the invention can further contain added ingredients to adjust texture and stability. Such routine adjustment of the composition is fully within the capabilities of one having skill in the art and is within the scope and intent of the present invention.

The following non-limiting example is provided:

### EXAMPLES

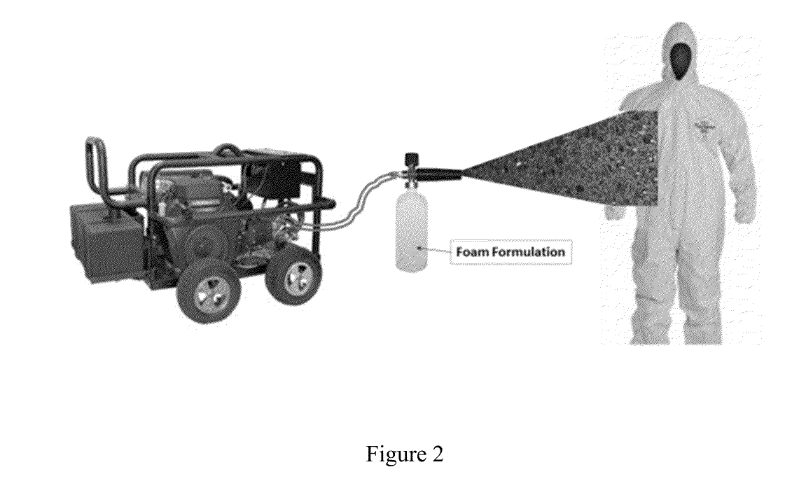

A foam lancer was used to develop foam. A schematic of the delivery is shown in FIG. 2. The bottle contained the following foam formulation: 980 ml of Clorox bleach solution and 20 ml of surfactant (LAPB+SLES=5 wt. %)+polymer (Jaguar13=0.1 wt %) solution.

The left hand side of the FIG. 2 schematic shows a pump of about 2500 psi, which can delivery water at >2 gallons per minute. In the present case, water was used to pump water through the foam lancer set-up (middle drawing in the FIG. 2 schematic).

We claim:

1. A disinfectant bleach foam composition comprising:
a hypochlorite;
one or more surfactants; and
one or more polymers.

2. The disinfectant bleach foam composition of claim 1, wherein the hypochlorite is selected from sodium hypochlorite (NaOCl) and potassium hypochlorite (KOCl).

3. The disinfectant bleach foam composition of claims 1, wherein the one or more surfactants are selected from the group consisting of betaines, alkyl ether sulfates, alkyl sulfates, alkyl sulfonates, alkyl aryl sulfonates, alkyl phenol ether sulfates, amine oxides, alkyl diphenyl oxide sulfonates, alkyl phosphonates, alkyl phosphate esters, etc., and mixtures thereof.

4. The disinfectant bleach foam composition of claims 3, wherein the one or more surfactants have from about 8 to 18 carbon atoms in the alkyl group.

5. The disinfectant bleach foam composition of claims 1, wherein the one or more surfactants is selected from the group consisting of alkyl ether sulfates, alkyl sulfates, alkyl sulfonates, K myristate, K caparate and K laurate.

6. The disinfectant bleach foam composition of claims 4, wherein the one or more surfactants have from about 8 to 18 carbon atoms in the alkyl group.

7. The disinfectant bleach foam composition of claims 3, wherein the one or more surfactants is selected to comprise:
one or more of an alkyl ether sulfates, alkyl sulfates, alkyl sulfonates, and alkyl aryl sulfonates, and
a betaine surfactant.

8. The disinfectant bleach foam composition of claims 1, wherein the one or more polymers are selected from cellulose derivatives and cationic polysaccharides.

9. The disinfectant bleach foam composition of any claim 8, wherein the one or more polymers are selected from guar hydroxypropyltrimonium chloride and carboxymethyl cellulose.
